(19) United States
(12) Patent Application Publication
(10) Pub. No.: US 2025/0028140 A1
(43) Pub. Date: Jan. 23, 2025

(54) One-Piece Lens Barrel Having High Sealing Performance

(71) Applicants: QIUHUA LIU, Shenzhen (CN); XINHUA LIU, Shenzhen (CN)

(72) Inventors: QIUHUA LIU, Shenzhen (CN); XINHUA LIU, Shenzhen (CN)

(73) Assignee: Shenzhen xin mao xin industrial co., LTD., Shenzhen (CN)

(21) Appl. No.: 18/462,195

(22) Filed: Sep. 6, 2023

(30) Foreign Application Priority Data
Jul. 19, 2023 (CN) 2023218964699
Jul. 21, 2023 (CN) 2023219904093

(51) Int. Cl. G02B 7/02

(52) U.S. Cl. CPC G02B 7/021; G03B 17/12

(57) ABSTRACT

A one-piece lens barrel having high sealing performance includes: a front shell and a bottom shell arranged at a middle of a bottom end of the front shell. Each of the front shell and the bottom shell is a one-piece and integral structure; and the front shell and bottom shell are fixedly connected to each other by laser soldering. A motherboard assembly is disposed at a middle of an inner cavity defined by the front shell and the bottom shell. At least three sets of positioning posts are connected to edges of a periphery of the motherboard assembly. and the at least three sets of positioning posts are uniformly distributed. The positioning posts are made of brass, and a surface of each positioning post is electroplated with tin.

### CROSS REFERENCE TO RELATED APPLICATIONS

The present application claims priority of the Chinese patent application No. 2023218964699, filed on 19 Jul. 23, and the Chinese patent application No. 2023219904093, filed on 27 Jul. 23, and the contents of which are incorporated herein by its entireties.

### TECHNICAL FIELD

The present disclosure relates to the field of front shell assembling, and in particular to a one-piece lens barrel having high sealing performance.

### BACKGROUND

A lens barrel, also known as a vehicle-mounted lens barrel, is a metal or plastic cylinder specifically configured for optical group lenses of a circumference fixed lens component. A length of the lens barrel may be varied as a focal length of the lens component varies. A diameter of the lens barrel is adapted with an aperture of the lens. A front end of a front shell is arranged with a screw for arranging a light shielding cover. A rear end of the lens barrel has a screw (a notch) to allow a camera to be arranged therein. For different lenses and cameras, the front shell is arranged with different components, such as a focus ring, an aperture adjustment shank (or a grating ring), a shutter vanadium, a zoom ring, and so on. In addition, the front shell may be engraved with a largest relative aperture of the lens, a focal length, or depth of day and so on.

While the front shell is being assembled, the applicant found that the above technology at least has the following technical problems:

1. While assembling a traditional front shell assembly, a dispensing process, a curing process, a screwing process, and so on, may be performed. The entire assembling process may be time consumed, complexed, have a low assembling efficiency, and have a high assembly cost.

2. A motherboard of the traditional front shell may be generally fixedly arranged, by screws and glue, inside the traditional front shell. However, when the screws and the glue are present in an environment of high temperatures and high humidity and are being vibrating for a long period of time, the screws and the glue may be melted and loose easily, resulting in the motherboard of the front shell to be shifted.

3. Various internal components of the traditional front shell are sealed with each other by seal rings. Further, the glue is applied for adhesion, and the screws are arranged for fixation. As the traditional front shell is being used for a long period of time, the seal ring and the glue may be aged, such that sealing performance may be affected, resulting in fog and dust being accumulated on the lens.

In order to solve the above problems, a one-piece lens barrel having high sealing performance is provided to solve the above problems.

### SUMMARY OF THE DISCLOSURE

The present disclosure provides a one-piece lens barrel having high sealing performance to solve the above problems.

In order to achieve the above objective, technical solutions of the present disclosure are as follows:

A one-piece lens barrel having high sealing performance includes: a front shell and a bottom shell arranged at a middle of a bottom end of the front shell. Each of the front shell and the bottom shell is a one-piece and integral structure; and the front shell and bottom shell are fixedly connected to each other by laser soldering. A depth of fusion bonding of the soldering process is 0.5 mm-0.7 mm. Laser soldering is performed on a connection between the front shell and the bottom shell to improve the sealing performance of the lens barrel after the soldering.

In some embodiments, a motherboard assembly is disposed at a middle of an inner cavity defined by the front shell and the bottom shell. At least three sets of positioning posts are connected to edges of a periphery of the motherboard assembly. The at least three sets of positioning posts are uniformly distributed. The positioning posts allows the motherboard assembly to be mounted and positioned quickly, improving an assembling efficiency.

In some embodiments, the at least three sets of positioning posts are fixedly mounted to the front shell and the bottom shell by a compression-riveting process.

In some embodiments, each of the at least three sets of positioning posts is made of brass, and a surface of each of the at least three sets of positioning posts is electroplated with tin.

In some embodiments, each of the bottom end of the front shell and the top of the bottom shell defines three sets of positioning holes. Each of the three sets of positioning holes is adapted with one of the at least three sets of positioning posts. A bottom of each of at least three sets of positioning posts is slidably mounted into a middle of an interior of a corresponding one of the three sets of positioning holes.

Due to the riveting, supportive forces and pulling forces applied by the positioning posts are improved, such that the motherboard assembly may be mounted stably, preventing the motherboard assembly from being loosened after being used in a long period of time.

According to the present disclosure, following technical effects can be achieved.

1. In the present disclosure, the front shell and the bottom shell are configured into a one-piece structure by performing a forging process. Further, the front shell and the bottom shell are soldered and sealed with each other by laser. In this way, an assembling process is simplified, the glue and the screws are omitted from the assembling process, and therefore, the assembling process is simple, efficient, and has low cost. An overall cost of the assembling process in the present disclosure is lower than an overall cost of assembling metal structures traditionally. In addition, cost of assembling the lens assembly is significantly reduced.

2. Since no screws and glue are used and the soldering process is performed, the motherboard assembly and the front shell are configured as the one-piece structure. In this way, the technical problem of the camera being loosened and shifted, caused by being used in the environment of high temperatures and high humidity, may be solved.

3. The one-piece lens barrel is formed by the forging process, and the front shell and the bottom shell are soldered with each other by the laser. Therefore, the front shell and the bottom shell are configured as a one-piece and integral structure, such that the front shell has high precision, and the problem of fogs being formed on the lens, caused by the seal ring and the glue in the traditional assembling process being aged, may be solved.

### BRIEF DESCRIPTION OF THE DRAWINGS

FIG. 1 is a structural schematic view of a one-piece lens barrel having high sealing performance according to an embodiment of the present disclosure.

FIG. 2 is an explosive view of the one-piece lens barrel having high sealing performance according to an embodiment of the present disclosure.

FIG. 3 is a bottom view of the one-piece lens barrel having high sealing performance according to an embodiment of the present disclosure.

Reference numerals in the drawings: 1, front shell; 2, bottom shell; 3, positioning post; 4, motherboard assembly; 5, positioning hole.

### DETAILED DESCRIPTION

The present disclosure will be illustrated in more details by referring to the accompanying drawings.

### Embodiments

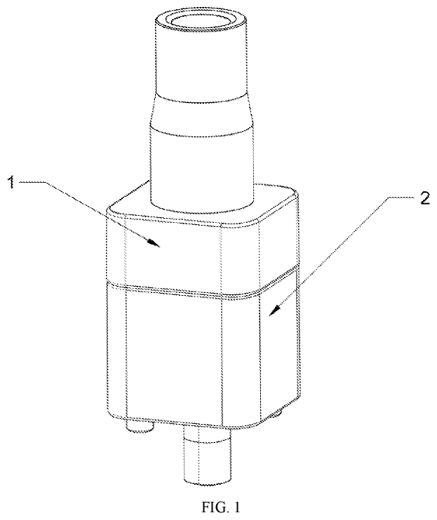

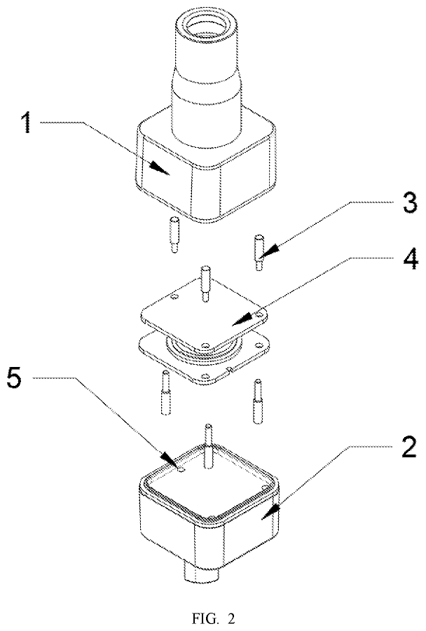

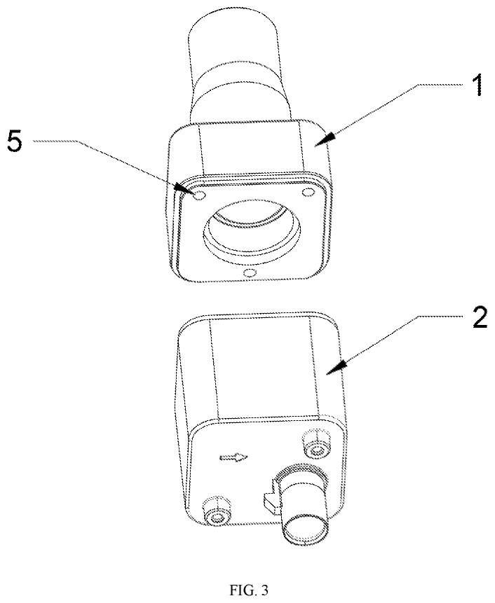

As shown in FIG. 1 to FIG. 3, a one-piece lens barrel having high sealing performance includes a front shell 1 and a bottom shell 2. The bottom shell 2 is arranged at a middle of a bottom end of the front shell 1. Each of the front shell 1 and the bottom shell 2 is a one-piece and integral structure. The front shell 1 and the bottom shell 2 are fixedly connected to each other by taking laser to perform a soldering process. A depth of fusion bonding generated by the soldering process is 0.5-0.7 mm, such that sealing performance of the lens barrel after the soldering process may be improved. The laser soldering may be performed by a device available in the art. In the soldering process, energy may be concentrated at a location, which is irradiated by the laser. In the soldering process, a laser device may continuously irradiate the laser for about 5 seconds. Further, a water cooling system device may be applied to reduce a temperature of the irradiated location rapidly to reach a room-temperature range, such that various components of the entire assembly are not affected.

In detail, the front shell 1 (may be made of AL6061) and the rear shell 2 (may be made of AL1050/AL1070) of the one-piece lens barrel are laser-soldered with each other after performing a cold forging process, placing on a NC lathe, performing a CNC, performing a sandblasting process, applying an anode layer, breaking the anode layer by performing CNC at a soldering position, and compression-riveting a positioning pin. In this way, an effect of “two omissions and four preventions” is achieved. That is, two structures (the glue and the screws are omitted) are omitted form the assembly to increase an assembling efficiency. The motherboard and the shell are configured into the one-piece structure, such that the camera, while being used in the environment of high temperatures and high humidity and being vibrated, may be stable. The lens barrel may be configured as the one-piece structure by the forging process. Therefore, the lens barrel may have a high precision. No glue is required in the assembling process, and therefore, the problem of fogs being formed on the lens, caused by the glue being aged, may be solved. In this way, the lens assembly may be permanently acid-proof, water-proof, fog-proof, and dust-proof.

A motherboard assembly 4 is disposed at a middle of an inner cavity defined in the front shell 1 and the bottom shell 2. At least three sets of positioning posts 3 are connected to edges of a periphery of the motherboard assembly 4. The at least three sets of positioning posts 3 are distributed evenly. For example, the at least three sets of positioning posts 3 may be distributed into a triangle. Due to the positioning posts 3, an operator may mount and positioned the motherboard assembly 4 quickly. Therefore, the assembling efficiency may be increased. Further, the soldering process is performed to connect and fix the motherboard assembly 4 to the shell. In this way, the motherboard module 4 may be mounted fixedly and stably, preventing the motherboard module 4 from falling off when being vibrated. Compared to the traditional fixation by the glue, an optical axis of the lens in the present disclosure and an optical axis of a chip on the motherboard assembly may not be displaced, while the lens barrel is being used in a bad situation of ultra-high or ultra-low temperatures.

For the front shell 1, the AL6061 material is used, and the cold forging process is performed. Further, the front shell 1 is a one-piece structure. Positioning holes are defined in the front shell 1 in advance. Therefore, 3 positioning posts may be compression-riveted accurately. In this way, the elements, such as the motherboard assembly, may be quickly assembled by performing only a simple soldering process, and complex processes, such as a dispensing process, a baking process, and a curing process, are omitted. The assembling efficiency and yield are improved, such that breakthrough in reducing the manufacturing cost may be achieved. In some embodiments, material of the positioning post 3 may be brass, and a surface of the brass may be electroplated with tin, and therefore, hardness and other properties of the positioning post 3 may be improved.

Each of the bottom end of the front shell 1 and a top end of the bottom shell 2 defines at least three positioning holes 5. More specifically, the number of the positioning holes is equal to the number of the positioning posts. The positioning posts 3 may be engaged with the positioning holes 5 correspondingly. A bottom of the positioning post 3 is slidably mounted in a middle of an interior of the positioning hole 5. The positioning post 3 is fixedly mounted to the front shell 1 and the bottom shell 2 by a compression-riveting process, such that the motherboard assembly 4 may be mounted stably.

A working principle of the present disclosure is as follows.

The forging process is performed to configure the front shell 1 and bottom shell 2 into the one-piece structure. Further, the front shell 1 and the bottom shell 2 are soldered and sealed with each other by the laser. The assembling process is simplified, and an assembling process without the glue and the screws are achieved. In addition, by arranging three sets of positioning posts 3 on each of the bottom of the front shell 1 and the top of the bottom shell 2, the operator may mount and position the motherboard assembly 4 rapidly, improving the assembling efficiency. The motherboard assembly 4 is further connected and fixed to the shell by the soldering process. Therefore, stability of the motherboard assembly 4 is improved. Based on the above, the process of assembling the front shell 1 and the bottom shell 2 is simplified. Compared to the traditional assembling process, the lens barrel in the present disclosure has decreased assembling cost and improved the assembling efficiency.

The above describes basic principles, major features, and the advantages of the present disclosure. Any ordinary skill in the art shall understand that the present disclosure is not limited by the above embodiments. The above embodiments and the description illustrate only the principles of the present disclosure. Various changes and improvements may be made to the present disclosure without departing from the spirit and scope of the present disclosure, and shall fall within the scope of the present disclosure. The scope of the present disclosure is defined by the appended claims and their equivalents.

What is claimed is:

1. A one-piece lens barrel having high sealing performance, comprising: a front shell and a bottom shell arranged at a middle of a bottom end of the front shell;
wherein each of the front shell and the bottom shell is a one-piece and integral structure; and
the front shell and bottom shell are fixedly connected to each other by laser soldering.

2. The one-piece lens barrel having high sealing performance according to claim 1, wherein a motherboard assembly is disposed at a middle of an inner cavity defined by the front shell and the bottom shell; at least three sets of positioning posts are connected to edges of a periphery of the motherboard assembly, and the at least three sets of positioning posts are uniformly distributed.

3. The one-piece lens barrel having high sealing performance according to claim 2, wherein the at least three sets of positioning posts are fixedly mounted to the front shell and the bottom shell by a compression-riveting process.

4. The one-piece lens barrel having high sealing performance according to claim 2, wherein each of the at least three sets of positioning posts is made of brass, and a surface of each of the at least three sets of positioning posts is electroplated with tin.

5. The one-piece lens barrel having high sealing performance according to claim 3, wherein each of the bottom end of the front shell and the top of the bottom shell defines three sets of positioning holes, each of the three sets of positioning holes is adapted with one of the at least three sets of positioning posts; and
a bottom of each of at least three sets of positioning posts is slidably mounted into a middle of an interior of a corresponding one of the three sets of positioning holes.

6. The one-piece lens barrel having high sealing performance according to claim 1, wherein a depth of fusion bonding of the soldering is 0.5 mm-0.7 mm.

7. A one-piece lens barrel, comprising: a front shell and a bottom shell arranged at a middle of a bottom end of the front shell;
wherein each of the front shell and the bottom shell is a one-piece and integral structure; the front shell and bottom shell are fixedly and undetachably connected to each other; and the bottom end of the front shell is fusion-bonded with a top of the bottom shell.

8. The one-piece lens barrel according to claim 7, wherein a motherboard assembly is disposed at a middle of an inner cavity defined by the front shell and the bottom shell; at least three sets of positioning posts are connected to edges of a periphery of the motherboard assembly, and the at least three sets of positioning posts are uniformly distributed.

9. The one-piece lens barrel according to claim 8, wherein the at least three sets of positioning posts are compression-riveted to the front shell and the bottom shell.

10. The one-piece lens barrel according to claim 8, wherein each of the at least three sets of positioning posts is made of brass, and a surface of each of the at least three sets of positioning posts is electroplated with tin.

11. The one-piece lens barrel according to claim 9, wherein each of the bottom end of the front shell and the top of the bottom shell defines three sets of positioning holes, each of the three sets of positioning holes is adapted with one of the at least three sets of positioning posts; and
a bottom of each of at least three sets of positioning posts is slidably mounted into a middle of an interior of a corresponding one of the three sets of positioning holes.

12. The one-piece lens barrel according to claim 7, wherein a depth of fusion bonding between the bottom shell and the front shell is 0.5 mm-0.7 mm.
